(19) United States
(12) Patent Application Publication
(10) Pub. No.: US 2010/0192509 A1
(43) Pub. Date: Aug. 5, 2010

(54) Repair Swatch For Hail Damaged Asphalt Roofing

(75) Inventors: Frederick W. Sieling, Bound Brook, NJ (US); William R. Carroll, Leesburg, FL (US); David A. Harrison, Wayne, NJ (US)

Correspondence Address: GAF Materials Corporation;Attn: William J. Davis, Esq., Legal Department, 1361 Alps Road, Building No. 8-2, Wayne, NJ, 07470, US

(73) Assignee: Building Materials Investment Corporation, Wilmington, DE (US)

(21) Appl. No.: 12/731,088

(22) Filed: Mar. 24, 2010

Related U.S. Application Data
(63) Continuation of application No. 11/362,297, filed on Feb. 24, 2006, now abandoned.

(51) Int. Cl. E04B 1/64; E04D 13/16; B32B 37/00

(52) U.S. Cl. 52/741.3; 52/741.4; 156/60

(57) ABSTRACT

A repair swatch (such as a patch) is provided that is preferably covered with appropriate granules on one face, with an opposite (back) face having an adhesive that allows the material to be placed over and adhere to small damaged areas of shingles and/or other types of roofing. The size, shape and color of the patch are such that it closely matches that of the existing shingle. Further, the size and shape of the patch are similar to shapes on laminated shingle products rendering the repair essentially invisible on such products.

### CROSS-REFERENCE TO RELATED APPLICATIONS

This application is a continuation of co-pending U.S. application Ser. No. 11/362,297, filed Feb. 24, 2006 and entitled “Repair Swatch for Hail Damaged Asphalt Roofing,” hereby incorporated by reference.

### BACKGROUND OF THE INVENTION

1. Field of the Invention

The present invention relates generally to the repair of damaged roofing, particularly roofing referred to as steep slope, and more specifically, to a repair swatch for the protection of part of a roofing that has been damaged, such as by extreme weather, hailstorms, foot traffic equipment installation or removal, or the like.

2. Prior Art

Asphalt-based roofing materials, such as roofing shingles, roll roofing and commercial roofing, are installed on the roofs of buildings to provide protection from the elements. Typically, the roofing material is constructed of a substrate such as a glass fiber mat or an organic felt, an asphalt coating on the substrate, and a surface layer of granules embedded in the asphalt coating.

The typical roofing material construction is suitable under most circumstances. However, sometimes a roofing material is subjected to environmental conditions that may damage the roofing material. For example, storms are responsible for billions of dollars in damage to roofing materials every year. During storms, hailstones may impact the roofing material, which may cause tears or punctures in the roofing material. The hailstone impacts may also cause an immediate loss of some granules from the impacted areas of the roofing material and a further loss of granules from those areas over time. The loss of granules creates an unattractive appearance and leaves the asphalt coating in those areas unprotected from the degrading effects of the elements. Even in cases where there are no obvious fabric ruptures the roof may be compromised since the exposed asphalt may prematurely age compromising the roof and/or adversely affecting the esthetics. Similarly foot traffic in hot weather can “scuff” the roof surface affecting the esthetics and ultimate durability of the roof. The installation of equipment or its removal can put holes in the roof with the potential to leak.

Losses sustained to building roofs caused by climatic conditions such as hail storms has focused development of roofing materials having increased impact resistance, and having an improved ability to withstand the destructive forces of storms. This need in the art is particularly acute in those geographic areas which are subject to these climatic conditions. Specifically, such areas as the Plain and Rocky Mountain states are particularly subject to roofing damage caused by hailstorms and the like. Indeed, the insurance laws of the state of Texas provide cash rebates to homeowners insurance policies wherein the insured property's roof employs Class 4 roof covering materials.

Further, roofing material that is storm proof has been developed in response to damages sustained by rooftops in geographic areas such as those described above. For example, U.S. Patent Publication No. 2002/0110679 provides for a storm proof roofing material where a protective coating is applied to the upper surface of the asphalt coating.

It is known to apply a surface coating onto a roof after the roofing shingles have been installed to protect the shingles from granule loss and other damage. Unfortunately, surface coatings require additional labor to apply after the roofing shingles have been installed, they are relatively expensive, and they may create safety problems by producing a slick roof. It is also known to manufacture roofing materials with polymer-modified asphalt to provide some improvement in impact resistance. Unfortunately, roofing materials made with polymer-modified asphalt are more difficult to manufacture, handle, store and install, and they are more expensive, than roofing materials made with conventional roofing asphalt. Also, the rubber-modified asphalt shingles are not completely effective in resisting impacts.

Also, when damage is sustained by the roofing, whether the impact resisting and storm proofing materials are used or not, the entire roofing of the structure may need to be replaced. This is a very expensive project for the owner, and can also take a long period of time for the complete replacement of the roof.

The above remarks establish the need in the art for a cheap and easy to install type of replacement for roofing material that has been damaged by hail storms or other conditions, and that does not require replacement of the entire roofing when the roofing has been partly damaged.

### SUMMARY OF THE INVENTION

The present invention provides a repair patch that protects and covers damaged areas of shingles or other roofing materials. Accordingly, a repair swatch for a damaged area of a roofing material is provided, the repair swatch comprising a front face having granules, and a back face having an adhesive to secure the repair swatch onto the roofing material. Further, the granules on the front face match granules on the roofing material. The roofing material can comprise a shingle. The adhesive is selected from a group consisting of a rubber polymer-modified asphalt, an acrylic, a polyurethane, a silicone and a rubber polymer. The repair swatch can be of a size that covers the damaged area of the roofing material. The shape of the repair swatch can be selected from a group consisting of square, rectangular, circular and dragon tooth.

Further, a method of repairing a damaged area of a roofing material is provided, the method comprising covering the damaged area of the roofing material with a repair swatch having a front side with granules, and securing a back side of the repair swatch to the roofing material.

The above and other features of the invention, including various novel details of construction and combinations of parts, will now be more particularly described with reference to the accompanying drawings and pointed out in the claims. It will be understood that the particular device embodying the invention is shown by way of illustration only and not as a limitation of the invention. The principles and features of this invention may be employed in various and numerous embodiments without departing from the scope of the invention.

### BRIEF DESCRIPTION OF THE DRAWINGS

These and other features, aspects, and advantages of the apparatus and methods of the present invention will become better understood with regard to the following description, appended claims, and accompanying drawings where:

FIG. 1 is a perspective view of a section of roof laid with shingles, with one or more shingles being damaged;

FIG. 2 illustrates a repair swatch in accordance with the principles of the present invention; and

FIG. 3 shows an application of the repair swatch of FIG. 2 to a section of roof laid with one or more damaged shingles as shown in FIG. 1.

### DETAILED DESCRIPTION OF THE PREFERRED EMBODIMENT

Although this invention is applicable to numerous and various types of roofing materials, it has been found particularly useful in the environment of roofing shingles. Therefore, without limiting the applicability of the invention to the above, the invention will be described in such environment.

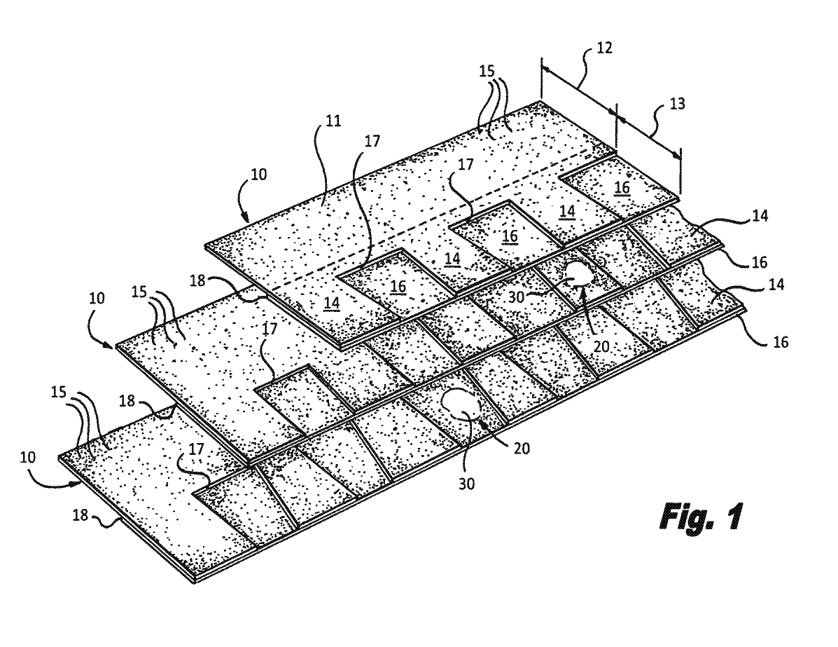

With reference now to the drawings, the present invention will be described. As shown in FIG. 1, a roof is generally laid out with many shingles in a formation such as shown in the figure. Each roofing shingle 10 generally includes a rectangular sheet 11 of asphalt-impregnated substrates, including webs, scrims, and felts of fibrous material, such as mineral fibers, cellulosic fibers, rag fibers, synthetic fibers and mixtures thereof. The asphalt coating employed in the production of roofing shingles encompass any type of bituminous material suitable for use as a roofing material. Thus, asphalts, tars, pitches and mixtures thereof are all encompassed within the meaning of the term “asphalt coating.” The asphalt can be either a manufactured asphalt, produced by refining petroleum, or a naturally occurring asphalt. The asphalt coating can include various additives and/or modifiers, such as inorganic fillers, mineral stabilizers, organic materials including polymers, recycled streams or ground tire rubber.

Each rectangular sheet 11 has a headlap portion 12, and a butt portion 13 which is divided into spaced apart tabs 14. An elongated strip 16 is secured to the sheet 11 at a position underlying the tabs 14. Preferably, a lower marginal edge 17 of the headlap portion 12 slightly overlaps an upper marginal edge 18 of the strip 16 and is secured thereto by asphaltic adhesive or other suitable means to ensure a watertight seal between the sheet 11 and strip 16. Each tab 14 is further secured to the strip 16 by adhesive or other suitable means.

The asphalt coating may include fillers, in the form of inorganic particulates or mineral stabilizers. Granules 15 are deposited in and over the top or exposed asphalt coating, such that granules 15 are deposited on the sheet 11 and the strip 16. During hail storms, it is these granules 15 that are damaged and are separated from the shingles 10. Damaged areas 20 of the shingles 10 therefore lack the protection provided by the granules 15, and the asphalt portion 30 of the shingle 10 is exposed. For purposes of description of the present invention, two damaged areas 20 are shown on the shingles laid out on the rooftop, with the exposed asphalt portions 30 showing. Obviously, more or less areas of the rooftop can be damaged.

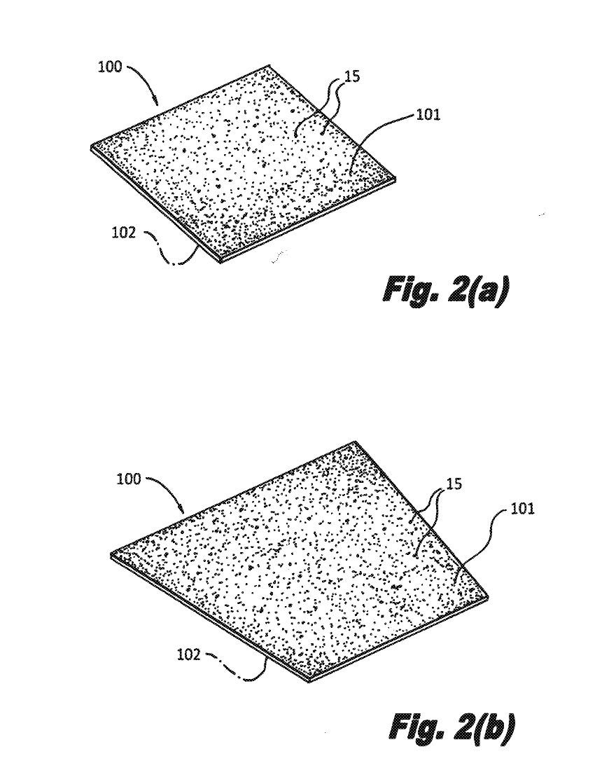

The present invention provides a repair swatch 100, as shown in FIGS. 2(a) and 2(b). FIG. 2(a) shows a repair swatch having a square shape, and FIG. 2(b) shows a repair swatch having a “dragon tooth” shape. Many different shapes are contemplated by the present invention, including but not limited to rectangular, circular, trapezoidal, etc., and are not limited by the shapes as shown in the figures. The size of the repair swatch can be of any size, and is preferably manufactured in many different sizes. Thus, a consumer can purchase the appropriate size depending on the size of the damaged area 20.

Each repair swatch has a front face 101 and a back face 102. The front face 1010f the repair swatch has granules 15 that match the granules 15 of the shingles 10. The back face 102 of the repair swatch contains an adhesive that allows the patch 100 to be secured onto the shingle 10, and specifically, the damaged area 20 of the shingle 10. Any type of adhesive that can secure the repair swatch onto the roofing material, or shingle, can be used, such as but not limited to a rubber polymer-modified asphalt, an acrylic, a polyurethane, a silicone or a rubber polymer. Different types and colors of granules 15 can be used, and the consumer can purchase the specific repair swatch 100 that matches the colors of the granules on the shingles or roofing of his/her particular roof.

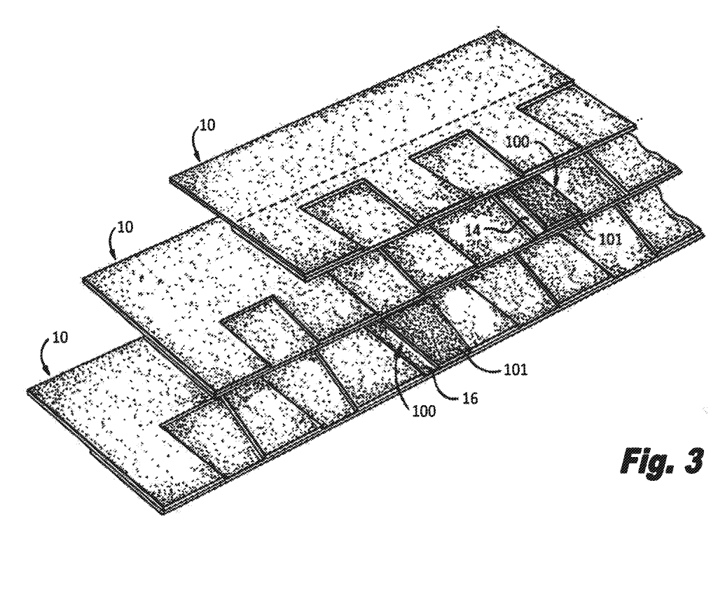

FIG. 3 shows the application of the repair swatch of FIG. 2 on the damaged areas 20 of the shingles 10 of FIG. 1. For purposes of the figure, a “dragon tooth” shape repair swatch 100 is placed on the damaged area of shingle 10a, and a square shape repair swatch 100 is placed on the damaged area of shingle 10b. The backside 102 of the repair swatch has the adhesive which is used to secure the repair swatch 100 onto the shingles 10a, 10b. The front face 101 has granules 15 that match the size and shape of the granules 15 of the shingles 10a, 10b. From a distance, the border of the repair swatch 100 cannot be seen as the granules 15 on the shingle 10 and repair swatch 100 match, so that it appears that the shingles 10a and 10b were never damaged.

The present invention provides several advantages that solve the problems with prior art methods. The repair swatch 100 provides the same protection as a brand new shingle would, making it a cheaper alternative to replacing shingles and/or the entire roofing. The granules on the front face of the repair swatch match the granules on the shingle, so that it is nearly impossible to tell that a repair swatch was placed on the shingle or that the shingle was ever damaged. The repair swatches come in various sizes and shapes, so that appropriate ones can be used or trimmed to size depending on the size and shape of the damaged area on the shingle or roofing material. Further, different colors and sizes of granules can be used on different sizes and shapes of repair swatches, so that the appropriate one can be used to match the damaged area of the particular shingle or roofing.

The above description of the present invention is only the preferred embodiment of the invention. Embodiments may include any currently or hereafter-known versions of the elements described herein. Different types, sizes, colors of granules can be used. Different sizes and shapes of repair swatches can be used, and any known adhesive can be used to secure the repair swatch securely to the shingle or roofing material. Although the invention was described in regard to damaged shingles, it is understood that the invention can be used on any type of applicable roofing material in accordance with the same principles described herein, and is not limited to shingles.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

1. A method for repairing a damaged roofing shingle having a damaged portion, comprising the steps of:
manufacturing a plurality of repair swatches, the plurality of repair swatches being manufactured in different sizes, different colors and different shapes;
allowing a consumer to match one of the plurality of repair swatches to the damaged roofing shingle based on (1) a color of the roofing shingle, (2) a shape of the damaged portion and (3) a size of the damaged portion;
allowing a consumer to purchase the matched repair swatch; and
securing the matched repair swatch to the damaged roofing shingle so that the repair swatch covers the damaged portion.

2. The method of claim 12 wherein the repair swatches include a front face having colored granules and a back face having an adhesive.

3. The method of claim 13 wherein the colored granules on the front face match colored granules on the damaged roofing shingle.

4. The method of claim 12 wherein the repair swatch is of a size that covers the damaged area of the roofing shingle.

5. The method of claim 12 wherein the shape of the repair swatch is one of a square, a rectangular, a circular and a dragon tooth.

6. The method of claim 12 wherein the roofing shingle is a laminated roofing shingle.

7. The method of claim 13 wherein the adhesive is selected from a group consisting of a rubber polymer-modified asphalt, an acrylic, a polyurethane, a silicone and a rubber polymer.

8. A method for repairing a damaged roofing shingle having a damaged portion, comprising the steps of:
manufacturing a plurality of repair swatches, the plurality of repair swatches being manufactured in different sizes, different colors and different shapes;
securing one of the plurality of repair swatches to the damaged roofing shingle so that the repair swatch matches the damaged roofing shingle and covers the damaged portion.

9. The method of claim 19 further comprising the step of:
matching one of the plurality of repair swatches to the damaged roofing shingle based on a color of the roofing shingle.

10. The method of claim 19 further comprising the step of:
matching one of the plurality of repair swatches to the damaged roofing shingle based on a shape of the damaged portion.

11. The method of claim 19 further comprising the step of:
matching one of the plurality of repair swatches to the damaged roofing shingle based on a size of the damaged portion.

12. The method of claim 22 wherein the repair swatch is of a size that covers the damaged portion of the damaged roofing shingle.

13. The method of claim 21 wherein the shape of the repair swatch is one of a square, a rectangular, a circular and a dragon tooth.

14. The method of claim 19 wherein the repair swatches include a front face having granules and a back face having an adhesive.

15. The method of claim 25 wherein the adhesive is selected from a group consisting of a rubber polymer-modified asphalt, an acrylic, a polyurethane, a silicone and a rubber polymer.

16. A method of manufacture, comprising the steps of:
manufacturing a plurality of repair swatches, the plurality of repair swatches being manufactured in different sizes, different colors and different shapes, the repair swatches including a front face having granules and a back face having an adhesive, at least one of the plurality of repair swatches matching a particular roofing shingle so that when the repair swatch is secured to the particular roofing shingle it is nearly impossible to tell that the repair swatch was placed on the particular roofing shingle.

17. The method of claim 27 wherein the granules on the front face of the repair swatch match granules on a front face of the particular roofing shingle.

18. The method of claim 28 wherein the repair swatch is of a size that covers a damaged portion of the particular roofing shingle.

19. The method of claim 29 wherein the shape of the repair swatch is one of a square, a rectangular, a circular and a dragon tooth.

20. The method of claim 30 wherein the adhesive is selected from a group consisting of a rubber polymer-modified asphalt, an acrylic, a polyurethane, a silicone and a rubber polymer.
